(19) United States
(12) Patent Application Publication
(10) Pub. No.: US 2016/0272389 A1
(43) Pub. Date: Sep. 22, 2016

(54) PACKAGING AND MATERIAL FOR MAKING SAME

(71) Applicants: Jun WANG, Fort Washington, PA (US); Todd VANGORDON, Basking Ridge, NY (US); Joel MILLON, Houilles (FR); Boxian LI, Guangzhou, Guangdong (CN); COLGATE-PALMOLIVE COMPANY, New York, NY (US)

(72) Inventors: Jun Wang, Fort Washington, PA (US); Joel Millon, Houilles (FR); BoXian Li, GuangZhou (CN); Todd VanGordon, Basking Ridge, NJ (US)

(21) Appl. No.: 15/033,162

(22) PCT Filed: Oct. 30, 2013
(86) PCT No.: PCT/CN2013/086208

§ 371 Date: Apr. 29, 2016

(51) Int. Cl. B65D 65/40; B32B 7/12; B32B 15/082; B65D 35/02; B32B 27/10; B32B 27/30; B32B 27/08; B32B 1/08; B32B 15/20

(52) U.S. Cl. CPC B65D 65/40; B32B 1/08; B32B 7/12; B32B 15/082; B32B 15/20; B32B 27/10; B32B 27/308; B32B 27/08; B65D 35/02; B32B 2250/05; B32B 2255/12; B32B 2307/7265; B32B 2307/7244; B32B 2439/40; B32B 2307/7246

(57) ABSTRACT

A laminate ma tend comprising in sequence from outermost layer to innermost layer: (a) an outer sealant layer comprising a thermoplastic polymer, (b) a paper layer, (c) a barrier layer, and (d) an inner sealant layer comprising a thermoplastic polymer, wherein the paper layer has a Scott bond strength of 250-450 J/m² is provided.

### FIELD OF THE INVENTION

This invention relates to novel deformable laminate materials and to containers made therewith, for example dispensing or packaging tubes for toothpaste, cosmetics, condiments, glues and other materials having the consistency of a paste, gel or cream. This invention also relates to methods of manufacturing such laminate materials and the use of such laminate materials to manufacture a packaging tube.

### BACKGROUND

Collapsible tubes formed of metallic and plastic materials are known in the packaging field. Conventionally, petroleum based plastics are used in tube packaging laminate materials. It is desirable to provide packaging materials that comprise, at least in part, renewable materials in order to reduce the use of petroleum based materials and obtain sustainability benefits. The incorporation of renewable or biodegradable materials is challenging however because the materials must still be able to provide the necessary physical properties in the final packaging article.

Paper is considered as a desirable material for inclusion in laminate materials for packaging because of its sustainability and biodegradability. However, packaging tubes made from laminate materials comprising per have been found to be unsuitable for packaging compositions such as toothpaste, cosmetics, condiments and glues because packaging articles manufactured from such materials are too weak (and therefore break upon dropping) and suffer from reel-breakage at the seam of the tube.

It would therefore be desirable to provide laminate materials that can overcome these difficulties.

### BRIEF SUMMARY

According to a first aspect of the present invention there is provided a laminate material comprising in sequence from outermost layer to innermost layer:
(a) an outer sealant layer comprising a thermoplastic polymer,
(b) a paper layer,
(c) a barrier layer and
(d) an inner sealant lager comprising a thermoplastic polymer
   wherein the paper layer has a Scott bond strength of 250-450 J/m².

Optionally the outer sealant layer comprises a polyolefin. Further optionally the outer sealant layer comprises a polypropylene or a polyethylene. Even further optionally the outer sealant layer comprises a polyethylene.

Optionally the inner sealant layer comprises a polyolefin. Further optionally the inner sealant layer comprises a polypropylene or a polyethylene. Even further optionally the inner sealant layer comprises a polyethylene.

Optionally the bather layer comprises a metal foil. Further optionally the barrier layer comprises aluminium.

Optionally the paper layer has a Scott bond strength of 300-450 J/m².

Optionally the laminate material further comprises a tie layer between the outer sealant layer and the paper layer, further optionally wherein the tie layer comprises a thermoplastic polymer selected from ethylene acid copolymers, ethylene acrylate copolymers, ethylene vinyl acetate copolymers, maleic anhydride modified ethylene acid copolymers, maleic anhydride modified ethylene acrylate copolymers, and maleic anhydride modified ethylene vinyl acetate copolymers.

Optionally the laminate material further comprises a tie layer between the paper layer and the barrier layer, further optionally wherein the tie layer comprises a thermoplastic polymer selected from ethylene acid copolymers, ethylene acrylate copolymers, ethylene vinyl acetate copolymers, maleic anhydride modified ethylene acid copolymers, maleic anhydride modified ethylene acrylate copolymers, and maleic anhydride modified ethylene vinyl acetate copolymers.

Optionally the laminate material further comprises a tie layer between the barrier layer and the inner sealant layer, further optionally wherein the tie layer comprises a thermoplastic polymer selected from ethylene acid copolymers, ethylene acrylate copolymers, ethylene vinyl acetate copolymers, maleic anhydride modified ethylene acid copolymers, maleic anhydride modified ethylene acrylate copolymers, and maleic anhydride modified ethylene vinyl acetate copolymers.

Optionally the outer sealant layer has a melt index of 1-6 g/10 min. Further optionally the outer sealant layer has a melt index of 2-4 g/10 min.

Optionally the inner sealant layer has a melt index of 1-6 g/10 min. Further optionally the inner sealant layer has a melt index of 2-4 g/10 min.

Optionally both the outer sealant lager and the inner sealant layer have a melt index of 1-6 g/10 min. Further optionally both the outer sealant layer and the inner sealant layer have a melt index of 2-4 g/10 min.

Optionally the laminate material comprises a tie layer and the tie layer has a melt index of 5-20 g/10 min.

Optionally the outer sealant layer has a thickness of 30-100 microns.

Optionally the inner sealant layer has a thickness of 30-100 microns.

Optionally the laminate material comprises a tie lager having a thickness of 30-100 microns.

Optionally the paper layer has a thickness of 30-100 microns.

Optionally the barrier layer has a thickness of 5-40 microns.

Optionally the laminate material has a total thickness of 200-400 microns.

Optionally the paper layer comprises a polymer coating. Further optionally the paper layer comprises a coating selected from ethylene acid copolymers, ethylene acrylate copolymers, ethylene vinyl acetate copolymers, low density polyethylene and linear low density polyethylene ethylene.

Optionally the outer sealant lager has a haze of 2 to 10%. Further optionally the outer sealant layer has a haze of 3-5 %.

According to a further aspect of the present invention there is also provided a method of manufacturing a laminate material comprising the steps of:
(i) coating the paper layer with a polymer;
(ii) laminating a first side of the coated paper layer with the outer sealant;
(iii) laminating the second side of the coated paper layer with the barrier;
(iv) laminating the barrier with the inner sealant.

Optionally the method further comprises a step of painting the paper layer with artwork, wherein the painting step takes place before the paper layer is coated with a polymer.

According to a further aspect of the present invention there is also provided use of a laminate material to manufacture a packaging tube.

According to a further aspect of the present invention there is also provided a packaging tube comprising a laminate material. Optionally the packaging tube has a top end, a bottom end and a flexible wall comprising a laminate material as described herein. Further optionally the packaging tube comprises a thermally bonded seam. Further optionally the packaging tube contains an oral care composition. Further optionally the packaging tube contains a dentifrice composition.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a cross-section representation of a laminate material according to the present invention.

FIG. 2A is a cross-section representation of a side seam in a packaging tube in which there is contact between the paste contents of the tube and the inner layers of the laminate material. FIG. 2B is a cross-section representation of a side seam in a packaging tube in which there is no contact between the paste contents of the tube and the inner layers of the laminate material.

FIG. 3 is a cross-section representation of a packaging tube according to an embodiment of the invention.

FIG. 4 is a cross-section representation of a 300 micron thick packaging tube according to an embodiment of the invention.

FIG. 5 is an example of the laminated structure of a packaging tube according to one embodiment of the present invention.

### DETAILED DESCRIPTION

The following description of the preferred embodiment(s) is merely exemplary in nature and is in no my intended to limit the invention, its application, or uses. As used throughout, ranges are used as shorthand for describing each and every value that is within the range. Any value within the range can be selected as the terminus of the range. In addition, all references cited herein are hereby incorporated by referenced in their entireties. In the event of a conflict in a definition in the present disclosure and that of a cited reference, the present disclosure controls.

Unless otherwise specified, all percentages and amounts expressed herein and elsewhere in the specification should be understood to refer to percentages by weight. The amounts given are based on the active weight of the material.

As used herein, the words “preferred” and “preferably” refer to embodiments of the invention that afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

It has now surprisingly been found that laminate materials in which petroleum based plastics are partially replaced by paper can be used to manufacture packaging articles including tubes for pastes, gels and creams. The laminate materials of the present invention can be used to package oral care compositions including dentifrice, for example toothpaste. In the materials of the present invention, the petroleum based plastic is partially replaced by a per layer which is located away from the packaged products and protected from the packaged products by an inner sealant layer and barrier layer. Furthermore the laminate materials can be used to manufacture a tube that provides 360 degree printing decoration capability together with a matte surface and soft-touch feel. Moreover, the replacement of the petroleum based plastic with the per layer results in a more sustainable and environmental friendlier laminate that provides a greater recyclability.

The paper layer should have a Scott bond test strength of 250-450 J/m². For example, the paper can have a Scott bond test strength of 260-440 J/m², 270-430 J/m², 280-420 J/m², 300-450 J/m², 325-450 J/m², 350-450 J/m², 350-425 J/m², 370-450 J/m², 370-425 J/m² or 380-450 J/m². Scott bond test strength is measured using the standard protocol TAPPI T 569 om-09 (also described in Reynolds, W. F. (1974): Tappi 3. 57(3), 116). Scott bond test strength measures the internal bond strength of a sheet of material and can be used for quantifying the delamination resistance of paper and board. Delamination is the macroscopic failure in the thickness direction of a sheet due to interfibre bond failure. The delamination resistance is equivalent to the energy lost when the paper is split into two halves. In order to measure Scott bond strength, a test specimen sheet is laminated between a metal block and one leg of a short length of aluminium angle using double-sided adhesive tape. This block is then placed in an instrument comprising a frame supporting a pendulum. When released, the pendulum strikes the upper edge of the angle, causing the sheet under investigation to split. The amount of potential energy lost dining the swing of the pendulum indicates the resistance to splitting of the material. A calibrated scale gives the resistance to splitting in terms of the loss of potential energy. The Scott bond rupture energy is expressed in energy units per unit surface, giving values in J/m².

Papers suitable for use as the paper layer in the laminate materials of the present invention include Kraft paper. In one embodiment, the paper has a weight of 50-100 g/m², for example 60-100 g/m², 60-90 g/m², 65-85 g/m² or 65-75 g/m². In one embodiment, the paper has a weight of 68.8 g/m².

In one embodiment, the paper layer has a thickness of 30-120 microns, for example, 30-100 microns, 40-100 microns, 50-90 microns, 60-90 microns, or 70-90 microns. In one embodiment, the paper layer has a thickness of 80 microns or 85 microns.

In one embodiment, the paper layer is coated with a polymer. The paper layer maybe coated on one or both sides. In one embodiment the polymer coating is selected from ethylene acid copolymers (such as, for example, ethylene acrylic acid copolymer (EAA) or ethylene methacrylic acid copolymer (EMAA)), ethylene acrylate copolymer (such as, for example, ethylene methyl acrylate copolymer (EMA), ethylene ethyl acrylate copolymer (EVA), or ethylene but acrylate copolymer (EBA)), ethylene vinyl acetate copolymer (EVA) or polyethylene (such as, for example, low density polyethylene (LDPE) or linear low density polyethylene (LLDPE)). In one embodiment the polymer coating is selected from ethylene acid copolymers such as EAA and EMAA. In one embodiment the polymer coating has a thickness of 5-25 microns, for example 5-20 microns, 5-10 or 6-9 microns. In one embodiment the polymer coating has a thickness of 8.5 microns. The paper layer maybe printed with artwork or other information.

In one embodiment, the paper layer is coated with a resin layer comprising EAA (for example DuPont Nucrel® 30707, DuPont Nucrel® 30907, Exxon Mobil Escor™ 5000 ExCo, Exxon Mobil Escor™ 6000 ExCo, Dow Chemical PRIMACOR™ 3002, Dow Chemical PRIMACOR™ 3440, Dow Chemical PRIMACOR™ 5980I), EMAA (for example DuPont Nucrel® 0407, DuPont Conpol™ 13B, DuPont Nucrel® 0609HS, DuPont Nuclel® 1214, DuPont Conpol™ 5B10SI), or EMA (for example DuPont Elvaloy® AC 1609, DuPont Elvaloy AC 1820, Westlake Chemical Corporation EMAC® SP2409, DuPont Elvaloy® AC 1913, Westlake Chemical Corporation MAC® SP2220). In one embodiment the paper layer is coated with a resin layer comprising LDPE, for example Dow™ LDPE 722, DOW™ LDPE 160C, DOWLEX™ 2035, ExxonMobil LDPE LD 220.4, DOW™ LDPE PG 7008, ExxonMobile™ LDPE LD 258, INEOS LDPE 20P430, Chevron Phillips Chemical Company LLC Marlex® 1003, Chevron Phillip Chemical Company LLC Marlex® 1009, DOW™ LDPE 780E, DO™ LLDPE 6200, DOW™ LDPE 9931.

The outer sealant layer comprises a thermoplastic polymer. In one embodiment, the outer sealant layer comprises a polyolefin. In one embodiment, the outer sealant layer comprises a polypropylene or a polyethylene. In one embodiment, the outer sealant layer comprises a polyethylene. In one embodiment, the outer sealant layer comprises linear low density polyethylene (LLDPE), low density polyethylene (LDPE), medium density polyethylene (MDPE) or high density polyethylene (HDPE). In one embodiment the outer sealant layer comprises linear low density polyethylene (LLDPE) and/or low density polyethylene (LDPE). In one embodiment, the outer sealant layer consists of polyethylene, for example linear low density polyethylene (LLDPE) and/or low density polyethylene (LDPE).

In one embodiment, the outer sealant layer has a high flowability to ensure deformation and flow at the side seam during heat sealing of a tube made using the laminate materials of the present invention. This ensures that the outer sealant layer covers up the edges of the other layers (including the paper layer) at the side seam and protects the other layers from contact with the contents of a tube at the side seam. Thus, water penetration into the paper layer at the side seam is minimized or eradicated. In one embodiment, the outer sealant layer has a melt index of 0.5-10 g/10 min, for example 1-6 g/10 min, 1.5-5 g/10 min, 2-4 g/10 min or 2.5-3.5 g/10 min. In one embodiment the outer sealant layer has a melt flow index of about 3 g/10 min. The melt index is measured at 190 DC/2.16 kg using the protocol described in ASTM D1238-ISO 1133.

In one embodiment the outer sealant layer has a thickness of 30-100 microns, for example 30-90 microns, 30-80 microns, 35-70 microns, 35-60 microns, 35-50 microns, 35-45 microns or 39-45 microns. In one embodiment the outer sealant layer has a thickness of 36, 37, 38, 39, 40, 41, 42, 43 or 44 microns. In one embodiment the outer sealant layer has a thickness of 40 microns.

In or embodiment the outer sealant layer is highly transparent. In one embodiment the outer sealant layer has a haze of 3-20%, for example 3-8%, 3-7%, 3-6% or 3-5%. In one embodiment the outer sealant layer has a haze of 3.5-4.5%, for example 4%. Haze is measured using a hazemeter and the protocol described in ASTM D1003.

The inner sealant layer comprises a thermoplastic polymer. In one embodiment, the inner sealant layer comprises a polyolefin. In one embodiment, the inner sealant layer comprises a polypropylene or a polyethylene. In one embodiment, the inner sealant layer comprises a polyethylene. In one embodiment, the inner sealant layer comprises linear low density polyethylene (LLDPE), low density polyethylene (LDPE), medium density polyethylene (MDPE) or high density polyethylene (HDPE). In one embodiment the outer sealant layer comprises linear low density polyethylene (LLDPE) and/or low density polyethylene (LDPE).

In one embodiment, the outer sealant layer consists of polyethylene, for example linear low density polyethylene (LLDPE) and/or low density polyethylene (LDPE).

In one embodiment, the inner sealant layer has a high flowability to ensure deformation and flow at the side seam during heat sealing of a tube made using the laminate materials of the present invention. This ensures that the inner sealant layer covers up the edges of the other layers (including the paper layer) at the side seam and protects the other layers from contact with the contents of a tube at the side seam. Thus, water penetration into the paper layer at the side seam is minimized or eradicated. In one embodiment, the inner sealant layer has a melt index of 0.5-10 g/10 min, for example 1-6 g/10 min, 1.5-5 g/10 min, 2-4 g/10 min or 2.5-3.5 g/10 min. In one embodiment the inner sealant layer has a melt flow index of about 3 g/10 min. The melt index is measured at 190° C./2.16 kg using the protocol described in ASTM D1238-ISO 1133.

In one embodiment the inner sealant layer has a thickness of 30-100 microns, for example 30-90 microns, 30-80 microns, 35-70 microns, 35-60 microns, 35-50 microns, 35-45 microns or 39-45 microns. In one embodiment the inner sealant layer has a thickness of 36, 37, 38, 39, 40, 41, 42, 43 or 44 microns. In one embodiment the inner sealant layer has a thickness of 40 microns.

The outer and inner sealant lagers can be a direct co-extruded layer, pre-formed multi-layered blown film or cast film. In one embodiment the outer and inner sealant layers have a melt index of 1-6 g/10 min, for example 2-4 g/10 min.

The barrier layer can protect the paper layer from the contents of a packaging tube manufactured from a laminate material of the present invention. Furthermore the barrier layer can provide a barrier to prevent the migration of substances such as water and oxygen through the laminate material and also provide structural rigidity to the laminate material. The barrier layer can comprise ethylene vinyl alcohol (EVOH), nylon, metallized polyethylene terephthalate (PET) film, metallized oriented polypropylene (OPP) film, polypropylene (PP) film coated with silicon oxide or a metal barrier. In one embodiment, the barrier layer comprises brass, chrome plate, copper, magnesium, nickel, silver, gold or aluminium metal. In one embodiment the bather layer comprises metallic foil, for example copper, magnesium, nickel, silver, gold or aluminium foil. In one embodiment the bather layer comprises aluminium foil. In one embodiment the barrier layer has a thickness of 5-40 microns, for example 5-30, 10-30 or 20-40 microns. In one embodiment the barrier layer comprises metallic foil and has a thickness of 6-13 microns. In one embodiment the barrier layer comprises metallic foil and has a thickness of 7-12 microns. In one embodiment the barrier layer comprises aluminium foil of 7, 9 or 12 microns thickness.

The various layers can be bonded directly one to the other, or can be bonded indirectly through the use of tie layers. The tie layers can be comprised of adhesives. In one embodiment the laminate material further comprises one or more tie layers. In one embodiment a tie layer is situated between the outer sealant layer and the paper layer. In one embodiment a tie layer is situated between the paper layer and the barrier layer. In one embodiment a tie layer is situated between the barrier layer and the inner sealant layer. In one embodiment a tie layer is situated in any two of the locations in the sandwich structure of the laminate material. In one embodiment the laminate material comprises a tie layer between the outer sealant layer and the paper layer, a tie layer between the paper layer and the barrier layer and a tie layer between the barrier layer and the inner sealant layer.

In one embodiment the tie layer comprises a thermoplastic polymer selected from anhydride modified polyolefins and ethylene acid copolymers. In one embodiment the tie layer comprises one or more polymers selected from ethylene acrylic acid copolymer (EAA) or ethylene methacrylic acid copolymer (EMAA)), ethylene acrylate copolymer (such as, for example, ethylene methyl acrylate copolymer (EMA), ethylene ethylene acrylate copolymer (EEA), or ethylene butyl acrylate copolymer (EBA)), or ethylene vinyl acetate copolymer (EVA). In one embodiment the tie layer comprises EAA (ethylene acrylic acid copolymer) or EMAA (ethylene-co-methacrylic acid). In one embodiment the tie layer consists of EAA (ethylene acrylic acid copolymer) or EMAA (ethylene-co-methacrylic acid). In one embodiment the tie layer consists of EAA (ethylene acrylic acid copolymer).

In one embodiment the tie layers have a melt index of 3-25 g/10 min, for example 3-20 g/10 min, 5-20 g/10 min, 8-20 g/10 min, 9-18 g/10 min, 10-18 g/10 min, 3-15 g/10 min or 2-12 g/10 min. The melt index is measured using ASTM D1238-ISO 1133 at 190° C. /2.16 kg. The combined melt index for co-extruded tie layer and polyethylene is optionally 8-18 g/10 min, for example 10-12 g/10 min measured using ASTM D1238-ISO 1133 at 190° C./2.16 kg.

In one embodiment, the tie layer comprises a resin selected from EAA (for example DuPont Nuclel® 30707, DuPont Nucrel® 30907, Exxon Mobil Escor™ 5000 ExCo, Exxon Mobil Ecor™ 6000 ExCo, Dow Chemical PRIMACOR™ 3002, Dow Chemical PRIMACOR™ 3440, Dow Chemical PRIMACOR™ 5980I), EMAA (for example DuPont Nucrel® 0407, DuPont Conpol™ 13B, DuPont Nucrel® 0609HS, DuPont Nuclel® 1214, DuPont Conpol™ 5B10SI), or EMA (for example DuPont Elvaloy® AC 1609, DuPont Elvaloy® AC 1820, Westlake Chemical Corporation EMAC® SP2409, DuPont Elvaloy® AC 1913, Westlake Chemical Corporation MAC® SP2220).

In one embodiment the laminate material comprises a co-extruded PE and tie layer. In one embodiment the laminate material comprises a co-extruded PE and tie laser in which the PE layer comprises LDPE, for example Dow™ LDPE 722, DOW™ LDPE 160C, DOWLEX™ 2035, ExxonMobil LDPE LD 220.48, DOW™ LDPE PG 7008, ExxonMobil™ LDPE LD 258, INEOS LDPE 20F430, Chevron Phillips Chemical Company LLC Marlex® 1003, Chevron Phillips Chemical Company LLC Marlex® 1009, DOW™ LDPE 780E, DOW™ LLDPE 6200, DOW™ LDPE 993I.

In one embodiment, the total thickness of the laminate material is 200-400 microns, for example, 250-430 microns, 280-400 microns, 280-430 microns, 280-375 microns, 280-350 microns, 280-330 microns or 280-320 microns. In one embodiment the total thickness of the laminate material is 300 microns.

The laminate materials of the present invention can be prepared by standard methods which are well known in the art. The laminate materials can be prepared by standard adhesive or extrusion lamination processes. In one embodiment, the paper is first printed with artwork and then coated with a thin laser of a polymer selected from LDPE, EAA and EMAA. The coated paper is then laminated with an outer sealant layer of PE and then laminated with the bather and inner sealant film.

Packaging tubes suitable for storing and dispensing oral care compositions such as dentifrice can be made from the laminate materials of the present invention using conventional tube-making machines and without changes to the standard process known in the art. For example, tubes can be manufactured using an AISA 2000 series machine. Tubes are manufactured with a heat sealed side-seam. The tubes maybe used for the packaging of oral care compositions. In one embodiment the tubes contains a dentifrice composition.

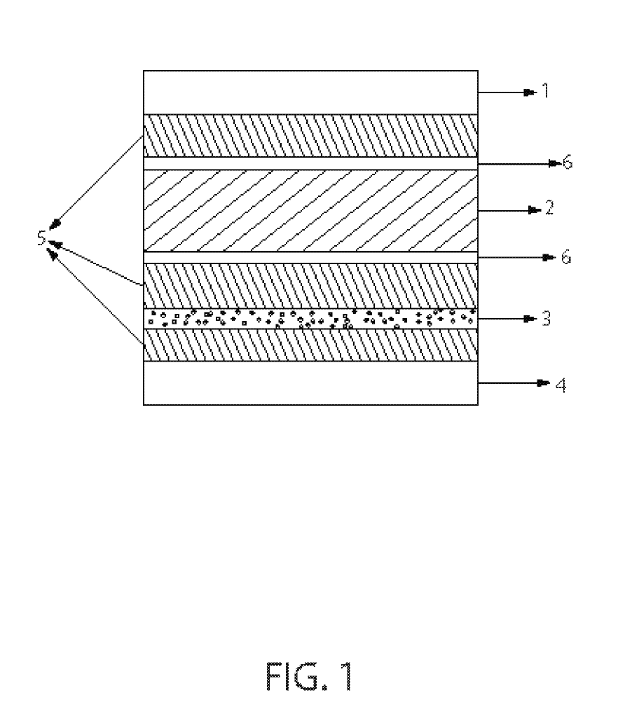

FIG. 1 shows a paper laminate structure according to the present invention comprising an outer sealant layer 1, payer layer 2, bather laser 3 and inner sealant layer 4. The layers are shown in order from outermost (top) to innermost (bottom). The outer layer 1 can be of variable thickness and is optionally located adjacent to a tie layer 5. The paper layer 2 is located between the outer layer 1 and barrier laser 3. The paper layer may be coated with a polymer coating 6. A further he laser 5 may be situated between the paper layer 2 and the bather layer 3, and also maybe situated between the barrier layer 3 and inner sealant layer 4. Thus the paper layer 2 is situated away from the packaged products and is protected by the inner sealant layer 4 and barrier layer 3.

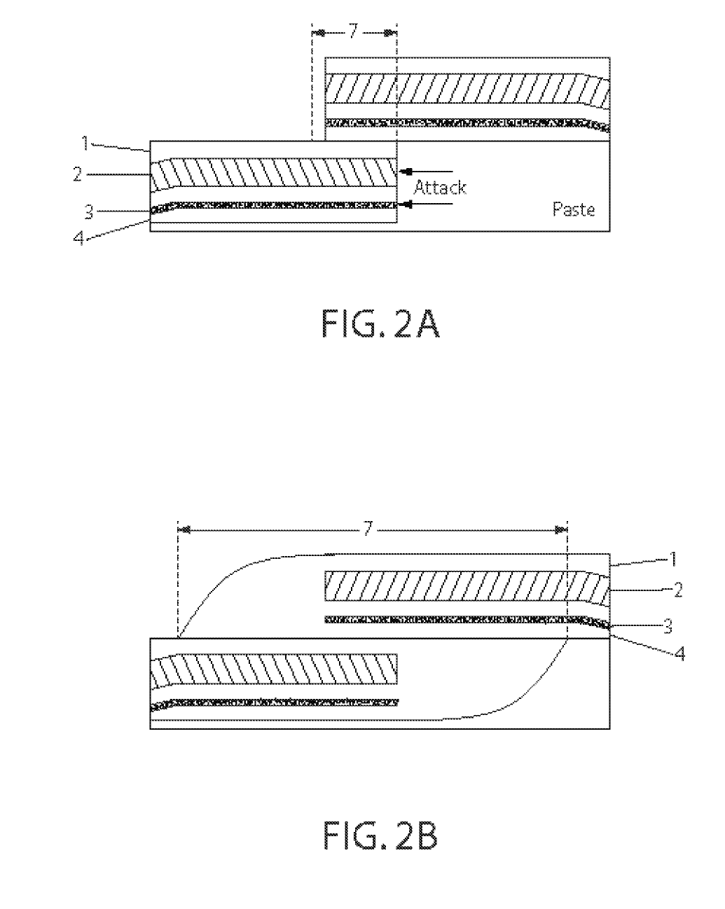

FIG. 2A shows a cross section of a side seam 7 of a tube manufactured from a laminate material with no protective coverage of the paper layer 2 and barrier laser 3 by outer and inner sealant layers 1 and 4. Thus the paper laser and barrier laser can be attacked by the contents of the package when formed into a sealed tube with a side seam. FIG. 2B shows a cross section of a side seam where the outer sealant 1 and inner sealant 4 provide good coverage of the paper layer 2 and bather laser 3 at the side seam and thus protect the paper layer 2 and bather layer 3 from the packaged contents. This is achieved by selecting materials with high flowability, reflected by their melt indices.

### EXAMPLES

### Example 1

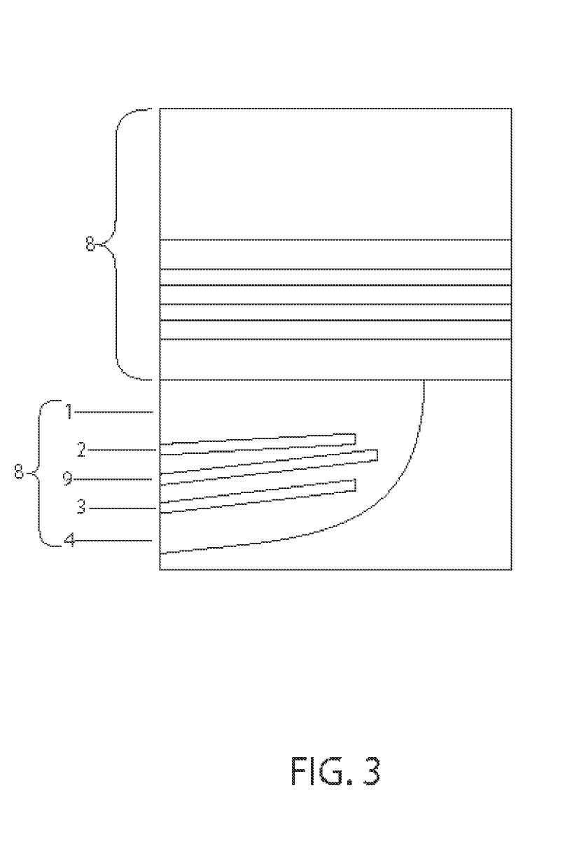

A laminate structure according to the present invention and having composition (from outermost to innermost):
44 μm PE/9 μm LDPE/printed paper/9 μm LDPE/35 μm PE/5 μm EAA/foil/5 μm EAA/16 μm PE/40 μm PE was prepared. The outer 44 μm LDPE sealant is an extrusion coated layer. The inner 40 μm PE sealant is a preformed multi-layer blow film. The barrier foil layer is aluminium foil. A tube of this laminate is made using an AISA tube-making machine. A representation of a microscopic photo of the side seam of this laminate is shown in FIG. 3 in which the whole laminate thickness 8 is made up of outer sealant PE 1, paper layer 2, barrier foil layer 3 and inner sealant 4 together with additional PE layer 9.

### Example 2

A laminate structure having composition (from outermost to innermost):
40 μm PE/20 μm LDPE/9 μm EAA/printed paper/9 μm EAA/40 μm PE-20 μm EAA/12 μm foil/10 μm EAA-40 μm PE/40 μm PE
   was prepared. In this example, both the outer and the inner PE sealant layers are preformed multi-layer blown films. The paper is coated with EAA. The foil layer is aluminium foil.

### Example 3

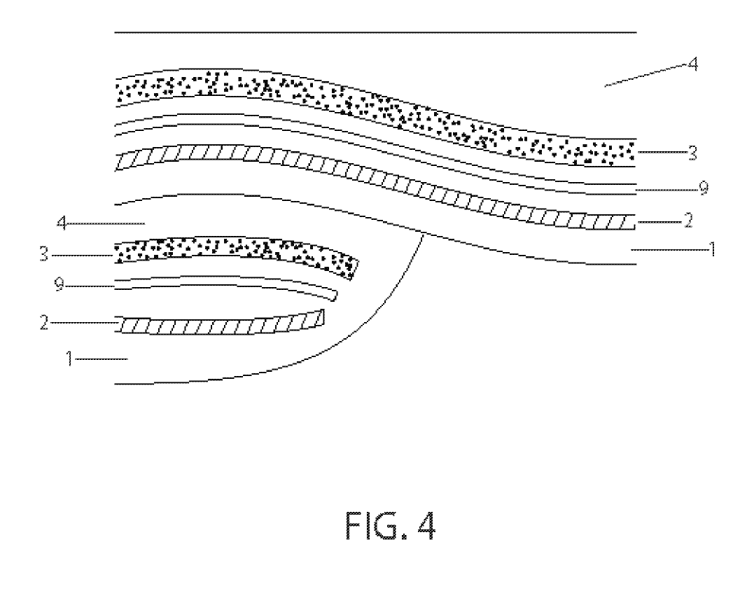

A laminate structure having composition (from outermost to innermost):
60 μm PE/85 μm printed paper/27 μm PE/20 μm PE with 2% white pigment masterbatch/20 μm EAA/12 μm foil/20 μm EAA/20 μm PE/38 μm PE
   was prepared. The 85 μm paper was first printed and then coated with 27 μm PE at one side and 60 μm PE at the other side to form the coated paper layer. The coated paper was then laminated onto the 12 μm foil via an extrusion laminated process to co-extrude 20 μm PE with 2% white pigment masterbatch and 20 μm EAA tie resin. The other side of the foil was then laminated onto a preformed PE sealant layer with a thickness of 38 μm by a co-extrusion of 20 μm EAA tie resin and 20 μm PE. The co-extruded PE is Dow LDPE 722 with a melt index of 8 g/10 min and the EAA resin is Dow Chemicals PRIMACOR™ 3002 with a melt index of 9.8 g/10 min. The total thickness of the laminate material is 300 μm. This laminate material produces a tube which passes the drop test and provides good coverage at the side seam. A representation of a microscopic photo of the side seam of this laminate is shown in FIG. 4 illustrating the outer sealant layer 1, paper layer 2, barrier layer 3, inner sealant layer 4, and additional PE layer 9.

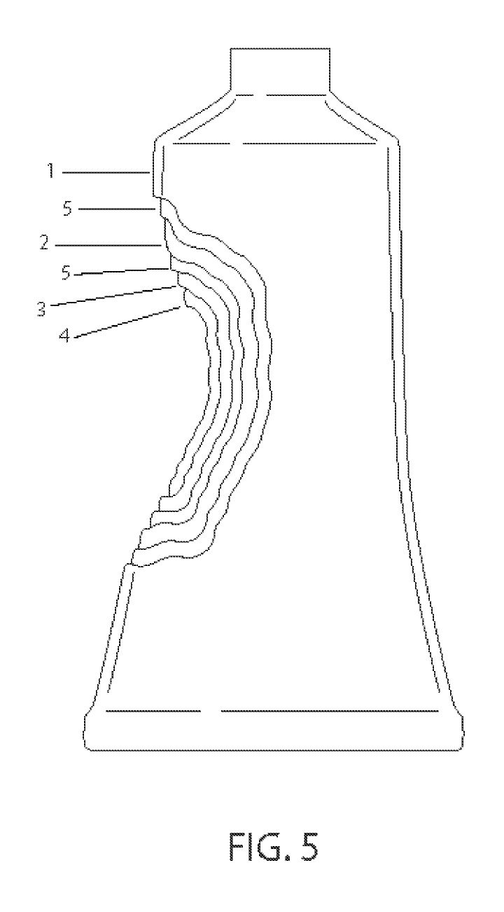

FIG. 5 is a representation of the laminated structure of a packaging tube according to the present invention illustrating the outer sealant layer 1, tie layers 5, paper layer 2, barrier layer 3 and inner sealant layer 4.

1. A laminate material comprising in sequence from outermost layer to innermost layer:
(a) an outer sealant layer comprising a thermoplastic polymer,
(b) a paper layer,
(c) a barrier layer, and
(d) an inner sealant layer comprising a thermoplastic polymer, wherein the paper layer has a Scott bond strength of 250-450 J/m².

2-12. (canceled)

13. The laminate material according to claim 1 wherein the barrier layer comprises a metal foil.

14. (canceled)

15. The laminate material according to claim 1 wherein the paper layer has a Scott bond strength of 300-450 J/m².

16. The laminate material according to claim 1 wherein the laminate material further comprises a tie layer between the outer sealant layer and the paper layer, optionally wherein the tie layer comprises a thermoplastic polymer selected from ethylene acid copolymers, ethylene acrylate copolymers, ethylene vinyl acetate copolymers, maleic anhydride modified ethylene acid copolymers, maleic anhydride modified ethylene acrylate copolymers and maleic anhydride modified ethylene vinyl acetate copolymers.

17. The laminate material according to claim 1 further comprising a tie layer between the paper layer and the barrier layer, optionally wherein the tie layer comprises a thermoplastic polymer selected from ethylene acid copolymers, ethylene acrylate copolymers, ethylene vinyl acetate copolymers, maleic anhydride modified ethylene acid copolymers, maleic anhydride modified ethylene acrylate copolymers, and maleic anhydride modified ethylene vinyl acetate copolymers.

18. The laminate material according to claim 1 further comprising a tie layer between the barrier layer and the inner sealant layer, optionally wherein the tie layer comprises a thermoplastic polymer selected from ethylene acid copolymers, ethylene acrylate copolymers, ethylene vinyl acetate copolymers, maleic anhydride modified ethylene acid copolymers, maleic anhydride modified ethylene acrylate copolymers, and maleic anhydride modified ethylene vinyl acetate copolymers.

19. The laminate material according to claim 1 wherein the outer sealant layer has a melt index of 1-6 g/10 min.

20-24. (canceled)

25. The laminate material according to claim 1 wherein the laminate material comprises a tie layer and wherein the tie layer claims has a melt index of 5-20 g/10 min.

26-30. (canceled)

31. The laminate material according to claim 1 wherein the laminate material has a total thickness of 200-400 microns.

32. The laminate material according to claim 1 wherein the paper layer comprises a polymer coating.

33. The laminate material according to claim 1 wherein the paper layer comprises a coating selected from ethylene acid copolymers, ethylene acrylate copolymers, ethylene vinyl acetate copolymers, low density polyethylene and linear low density polyethylene ethylene.

34. The laminate material according to claim 1 wherein the outer sealant layer has a haze of 2-10%.

35-37.

38. A packaging tube comprising a laminate material according to claim 1.

39. The packaging tube of claim 34 having a top end, a bottom end and a flexible wall comprising the laminate material.

40. (canceled)

41. The packaging tube of claim 34 wherein the packaging tube contains an oral care composition.

42. (canceled)
